(19) United States
(12) Patent Application Publication
(10) Pub. No.: US 2006/0048622 A1
(43) Pub. Date: Mar. 9, 2006

(54) Electrically-driven tape cutter

(75) Inventor: Hiroyuki Araki, Chiba-shi, Chiba (JP)

Correspondence Address: GREENBLUM & BERNSTEIN, P.L.C., 1950 ROLAND CLARKE PLACE, RESTON, VA, 20191, US

(73) Assignee: KTF Corporation, Tokyo (JP)

(21) Appl. No.: 10/517,777

(22) PCT Filed: Mar. 30, 2004
(86) PCT No.: PCT/JP04/04547

§ 371 Date: Dec. 27, 2004

(51) Int. Cl. B26D 1/00

(52) U.S. Cl. 83/694

(57) ABSTRACT

The invention provides an improved electric tape cutter in which a pinion gear with an attached magnet that is connected to a drive source is embedded with a member having a weight equal to that of the magnet at a location that is symmetrical to the location at which the magnet is mounted, with respect to a center axis of rotation, imparting balanced rotation that enables eccentric rotation of the pinion gear to be prevented, preventing noise and apparatus malfunction. The electric tape cutter, which feeds a leading edge of adhesive tape wound on a reel from a delivery outlet and cuts it to an appropriate length with an electrically driven blade provided at the delivery outlet, has a configuration wherein, in order to prevent eccentric rotation of a pinion gear that has a magnet affixed thereto and is connected to a drive source, a fitted member of equal weight to the magnet is embedded in the pinion gear at a location that is symmetrical to the position at which the magnet is provided, with the axis of rotation of the pinion gear therebetween.

### BACKGROUND OF THE INVENTION

1. Technical Field

The present invention relates to an electric tape cutter that electrically drives adhesive tape wound on a reel to feed the tape from a delivery outlet and automatically cut it to an appropriate length. It particularly relates to an electric tape-cutter having a pinion gear to which a magnet is affixed connected to a drive source (motor) in which a fitted member having a weight equal to that of the magnet is embedded in the pinion gear at a position that is axially symmetrical to that of the magnet.

2. Description of the Prior Art

Electric tape cutters in which adhesive tape wound on an annular member such as a reel or the like is fed out from a delivery outlet of a housing of a drive apparatus until a prescribed length is reached at which an electrically driven blade provided on the delivery outlet is operated to cut the tape are already known in, for example, Unexamined Patent Application Publication No. 6-71972 and Unexamined Utility Model Application Publication No. 7-5087. Electric tape cutters in recent years are equipped with a magnetic sensor that controls the length of tape that is delivered. For example, by means of a magnet mounted on a pinion gear connected to a drive source, control is carried out to deliver 1 mm for one revolution of the magnet.

However, because the magnet mounted on the pinion gear is embedded at one location on the pinion gear, rotation of the motor or the like that is the drive source becomes rotation that is off-center from the balanced weight. An eccentrically rotating member mounted on the revolving shaft of a motor or the like gives rise to vibration and sounds, causing operation of the overall apparatus to produce noise.

Also, vibration caused by the eccentricity is transmitted to the overall apparatus, and use for an extended period of time can cause separation of the substrate pattern and, by extension, can cause malfunction of the overall apparatus.

Thus, the development of an apparatus has been awaited that can avoid eccentric rotation of the pinion gear and provide stable mechanical operation and avoid malfunctions by suppressing;the generation of noise and preventing vibration.

To resolve the above problems, an object of the electric tape cutter of this invention is to provide an improved electric tape cutter in which a pinion gear with an attached magnet that is connected to a drive source is embedded with a member having a weight equal to that of the magnet at a location that is symmetrical to the location at which the magnet is mounted, with respect to a center axis of rotation, imparting balanced rotation that enables eccentric rotation of the pinion gear to be prevented, preventing noise and apparatus malfunction.

### SUMMARY OF THE INVENTION

To attain the above object, this invention provides an electric tape cutter that feeds a leading edge of adhesive tape wound on a reel from a delivery outlet and cuts it to an appropriate length with an electrically driven blade provided at the delivery outlet, wherein in order to prevent eccentric rotation of a pinion gear that has a magnet affixed thereto and is connected to a drive source, a fitted member of equal weight to the magnet is embedded in the pinion gear at a location that is symmetrical to the position at which the magnet is provided, with the axis of rotation of the pinion gear therebetween. The object is also attained by an electric tape cutter in which the fitted member is composed of brass.

Further features of the invention, its nature and various advantages will be more apparent from the accompanying drawings and following detailed description of the invention.

### BRIEF DESCRIPTION OF THE DRAWINGS

FIG. 1 is a perspective view of the electric tape cutter of the invention.

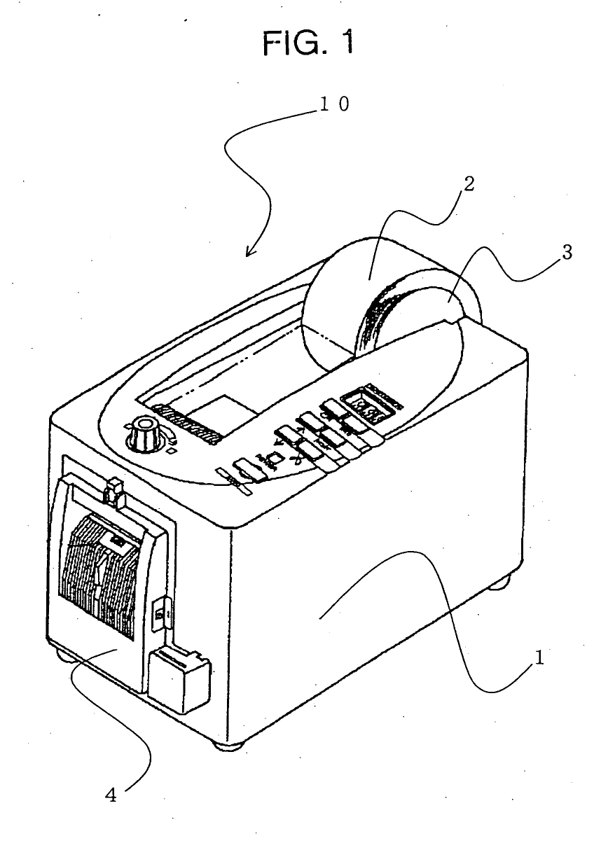

FIG. 2 shows the configuration of the pinion gear.

FIG. 3 is a disassembled view of the electric tape cutter.

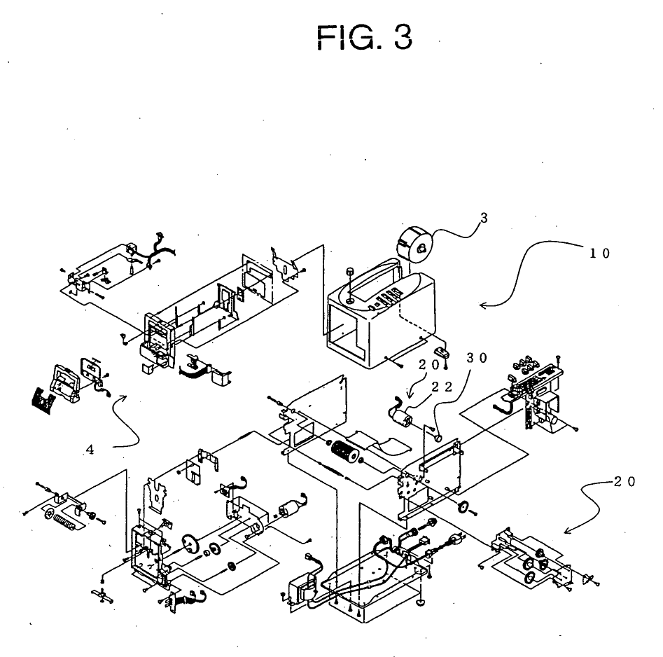

### DESCRIPTION OF THE PREFERRED EMBODIMENT

Details of the electric tape cutter of the invention will now be explained with reference to the drawings.

An electric tape cutter 10 according to the present invention comprises adhesive tape 2 wound on a reel 3, a drive unit 20 that feeds the tape from a delivery outlet, and a cutter unit (electrically driven blade) 4. The reel 3 on which the adhesive tape 2 is wound is mounted on the tape cutter body 1, and the drive unit 20 is operated to pay out the adhesive tape, which is automatically cut at a prescribed length by the cutter unit 4. This structure is the same as that of a conventional electric tape cutter.

In this embodiment, details will now be explained with respect to an improved pinion gear 30 for preventing noise, provided on the drive unit 20.

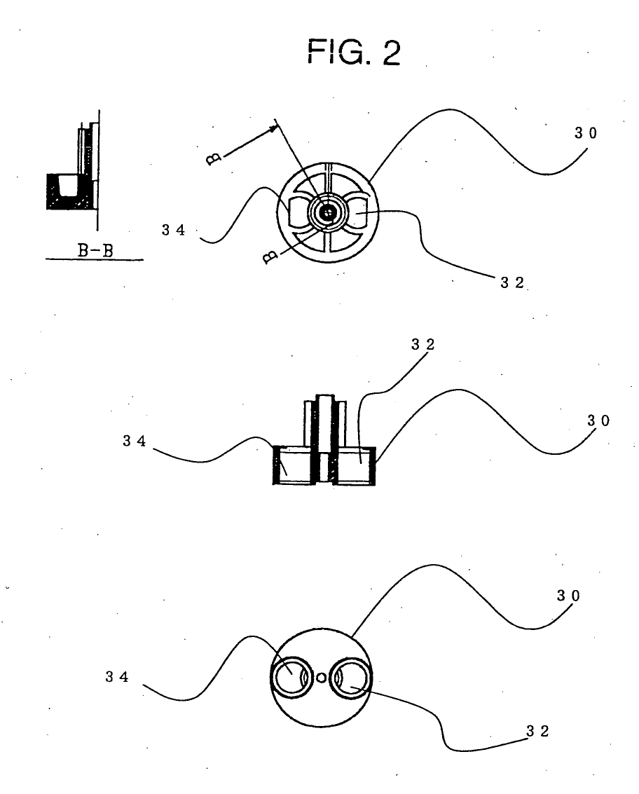

A control switch (not-shown) is used to supply electric power from a power supply to operate the drive unit 20 and feed out tape 2 from the reel 3. The drive unit 20 is equipped with a motor 22 that is connected to the pinion gear 30 to transmit the rotational motion. As shown in FIG. 2, a magnet 32 used for sensing the tape length is attached to the surface of the pinion gear 30. Where the configuration differs from a conventional pinion gear is that a fitted member 34 having a weight equal to that of the magnet 32 is embedded at a position that is symmetrical to the position at which the magnet 32 is provided, with respect to the axis of rotation. By means of a magnetic sensor (not shown), the magnet 32 is used to count the number of revolutions of the pinion gear 30 connected to the drive source, constituting a sensing apparatus for controlling the length of tape that is delivered. To ensure that each rotation is electromagnetically clearly distinguished, the magnet is fitted at a position away from the center of rotation to enable rotation of the rotor to be detected.

The fitted member 34 has the same shape as the magnet and, in order to prevent eccentric rotation of the pinion gear 30, is provided at a position that is symmetrical to that of the magnet, with respect to the center axis of the pinion gear. It is preferable to use a material having a specific gravity equal to that of the magnet. It is also preferable to use a material that is not subject to the effect of magnetic force, so that it cannot be sensed by the magnetic sensor. In this embodiment, brass is used for the fitted member. It-is also possible to reduce the size by using a material having a different specific gravity.

Providing the pinion gear 30 with a member having the same weight as the magnet balances the pinion gear, so that it does not rotate eccentrically when the electric tape cutter is operated. In the prior art, because the pinion gear rotated eccentrically at an off-center position, rotation was accompanied by vibration, making the electric tape cutter very noisy in operation. Since in the present invention a fitted member having the same weight is embedded at a position that is axially symmetric to the magnet, while the member may be slightly heavy, rotation is smooth with no shaking. The change in the overall weight from the addition of the fitted member is very small, the weight change from the member relative to the weight of the body of the apparatus being negligible.

The smooth rotation makes it possible to prevent noise generated by vibration. Also, while eccentric rotation caused vibration that was transmitted to the overall apparatus and became a cause of malfunction of the drive source and the pinion gear, due to the normal operation of the pinion gear, it becomes possible to suppress the occurrence of malfunctions.

In accordance with the electric tape cutter having the foregoing configuration according to this invention, a pinion gear to which a magnet is affixed is provided with a member that is symmetrical to the magnet with respect to the center axis of the pinion gear, thereby preventing eccentric rotation and making it possible to prevent noise and apparatus malfunction. Moreover, since the fitted member is brass, the weight can be freely adjusted, and the specific gravity is close to that of the magnet, so by giving it the same shape, the fitted member provides precise balancing.

What is claimed is:

1. An electric tape cutter that feeds a leading edge of adhesive tape wound on a reel from a delivery outlet and cuts it to an appropriate length with an electrically driven blade provided at the delivery outlet, wherein in order to prevent eccentric rotation of a pinion gear that has a magnet affixed thereto and is connected to a drive source, a fitted member of equal weight to the magnet is embedded in the pinion gear at a location that is symmetrical to the position at which the magnet is provided, with the axis of rotation of the pinion gear therebetween.

2. The electric tape cutter as described in claim 1, in which a material of the fitted member is brass.
